(19) United States
(12) Patent Application Publication
(10) Pub. No.: US 2017/0261025 A1
(43) Pub. Date: Sep. 14, 2017

(54) SHEAR SCREW NAIL

(71) Applicant: Ching-Yen Hsieh, Taichung City (TW)

(72) Inventor: Ching-Yen Hsieh, Taichung City (TW)

(21) Appl. No.: 15/067,186

(22) Filed: Mar. 11, 2016

(51) Int. Cl. F16B 31/02; F16B 15/00

(52) U.S. Cl. CPC F16B 31/021; F16B 15/00

(57) ABSTRACT

Disclosed is a shear screw nail, adapted to be in connection a steel skeleton, and comprising a resistance body, configured with a connecting portion at a predetermined position thereof, the connecting portion being hollow inside and configured with at least one connecting recess, and one end of the resistance body being configured with a flange, the width of which is larger than the resistance body. Whereby, a connecting body is in connection with the connecting portion, penetrated through a plate body and supporting body, and then locked through a fixing body and locking body at the penetration end thereof to fix the plate body and supporting body, thereby achieving the effects of fixing the plate body and supporting body and strengthening the breaking strength of the steel skeleton.

### (a) TECHNICAL FIELD OF THE INVENTION

The present invention relates to a shear screw, and more particularly to a shear screw, in connection with a steel skeleton through a resistance boy in such a way to increase the breaking strength of the steel skeleton, and a connecting body, fixing body and locking body through a connection portion so as to further fix a plate body and supporting body.

### (b) DESCRIPTION OF THE PRIOR ART

General steel skeleton structure wall building procedures mostly are: combining steel beams into a main skeleton; welding connection nuts separately in a section of the main steel skeleton frame; connecting the nuts respectively with a steel bar; surrounding a molding plate and a support steel plate outside; piercing the steel body through the molding plate and supporting steel plate to connect a fixing plate and locking nut so as to fix the molding plate and supporting steel plate; and finally carrying out a concreting operation, thereby building house walls. However, these steel structure combination procedures are very time and cost consumptive because the connection of the steel carcass with the main steel skeleton in general reinforced concrete (RC) structure is to connect steel bars after separately arranged connection nuts are welded and fixed to the main steel skeleton.

### SUMMARY OF THE INVENTION

A plurality of steel beams are generally used to combine into a main framework of a construction, and a plurality of shear nails are arranged distantly to be in connection with the surfaces of the steel beams so as to strengthen the breaking strength of the steel beams. Therefore, the shear mail may be in connection with a connecting body, and the connecting body may then a fixing body and locking body in such a way to fixing a molding plate and supporting steel plate effectively so as to carrying out a follow-up concreting operation.

To achieve the effects mentioned above, the present invention proposes a shear screw nail, adapted to be in connection with a steel skeleton, and mainly including a resistance body, on a predetermined position of which a connecting portion is configured, the connection portion being hollow inside and configured with at least one connecting recess, on one end of which a flange is configured.

The connecting portion is configured on a center of the resistance body mentioned above.

A welding portion is configured on another end of the resistance body mentioned above, which is welded to a steel skeleton through the welding portion.

The resistance body mentioned above is a shear nail.

The connecting portion mentioned above is in connection with one end of a connecting body.

The flange mentioned above is larger than the resistance body in width.

The flange mentioned above is circular, rectangular, triangular, hexagonal or octagonal.

The connecting recess mentioned above is a spiral recess.

### BRIEF DESCRIPTION OF THE DRAWINGS

FIG. 1 is a perspective view of the present invention;

FIG. 2 is a cross-sectional view of the present invention;

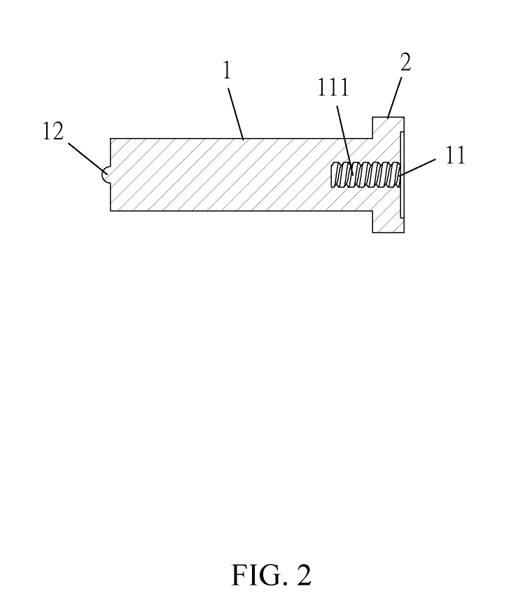

FIG. 3 is a perspective view of the present invention in connection with a connecting body;

FIG. 4 is a schematic view of the present invention, where a plate body is fixed;

FIG. 5 is a side view of the present invention, where a plate body is fixed;

FIG. 6 is a schematic view of the present invention illustrating how to fix a distance between a steel skeleton and plate body; and

FIG. 7 is a schematically perspective view of the present invention with a hexagonal flange.

### DETAILED DESCRIPTION OF THE PREFERRED EMBODIMENTS

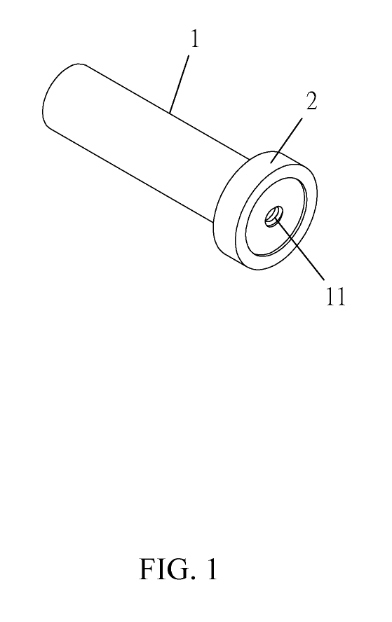

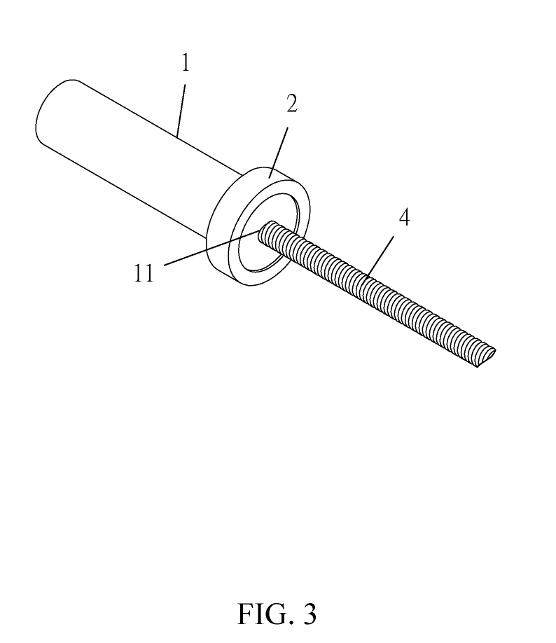

Referring to FIGS. 1 and 3, which respectively are a perspective view, cross-sectional view of the present invention and a perspective view of the present invention in connection with a connecting body, a shear screw nail of the present invention mainly includes a resistance body 1, on the center of which a connecting portion 11 is configured, where the connecting portion 11 is hollow inside and configured with at least one connecting recess 111. One end of the resistance body 1 is configured with a flange 2 having a width larger than the resistance body 1, and another end of the resistance body 1 is configured with a welding portion 12, through which the resistance body 1 can be welded to a steel skeleton 3.

The resistance body 1 is a shear nail.

The connecting portion 11 mentioned above is in connection with one end of a connecting body 4.

The flange 2 mentioned above is circular, rectangular, triangular, hexagonal or octagonal.

The connecting recess 111 mentioned above is a spiral recess.

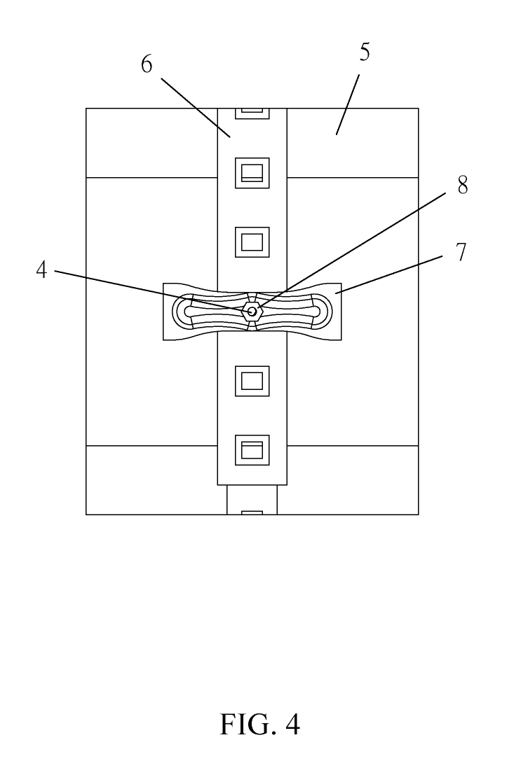

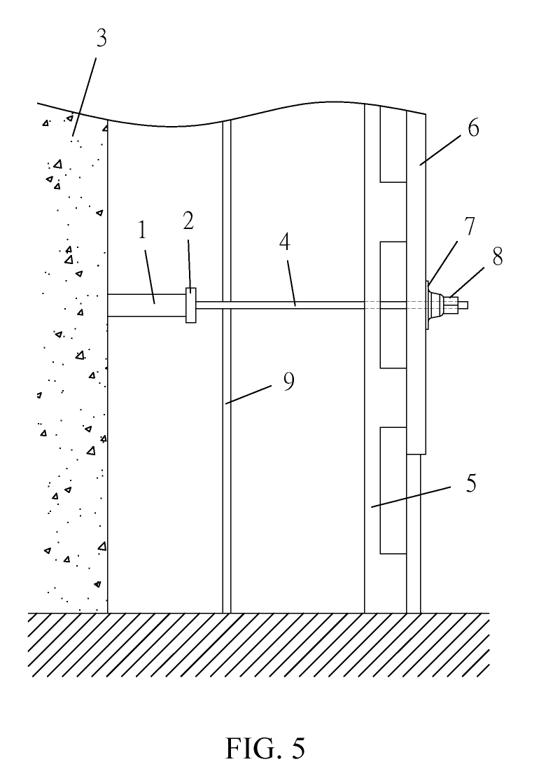

Referring to FIGS. 3 to 5, which respectively are a perspective view of the present invention while a connecting body is in a use state, a schematic view of the present invention where a plate body is fixed, and a side view of the present invention where a plate body is fixed, another end of the resistance body 1 is welded to the steel skeleton 3, and the center of the resistance body 1 is configured with the connecting portion 11, through which the resistance body 1 is in connection with one end of the connecting body 4, with another end of the connecting body 4 being passed through a plate body 5 and supporting body 6, where the supporting body 6 is configured on the outer side of the plate body 5, and one face of the supporting body 6 is attached to one face of the plate body 5 so as to support the plate body 5 effectively, Furthermore, another end of the connecting body 4 is fixed with a fixing body 7, one face of which is pressed against another face of the supporting body 6, and further locked with a locking body 8. which is positioned on another face of the fixing body 7 so as to position the fixing body 7, where the pressing force of the fixing body 7 and the locking force of the locking body 8 can further support the supporting body 6 so as to stabilized the plate body 5 effectively. Furthermore, a supporting steel bar 9 is configured and a predetermined hollow space is defined between the plate body 5 and steel skeleton 3, where the hollow space is used for concrete to be filled in so as to construct a wall effectively. Thus, the plate body and supporting body can be fixed effectively while the breaking strength of the steel skeleton can be strengthened.

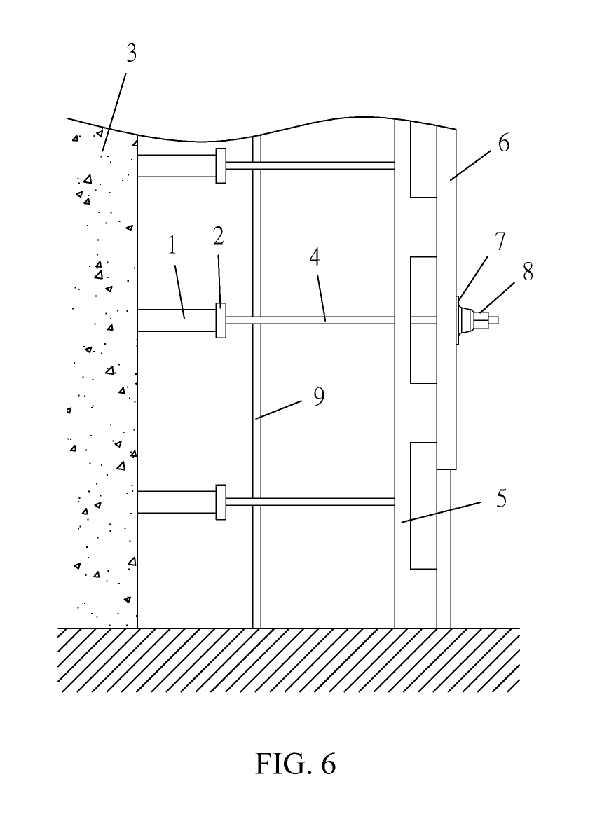

Referring to FIG. 6, which is a schematic view of the present invention illustrating how to fix a distance between a steel skeleton and plate body, the connecting portion 11 of each resistance body 1 is in connection with the connecting body 4, the length of which may be adjusted depending on a user's requirements. One of the connecting bodies 4 is set to be longer in such a way to pass through the plate body 5 and supporting body 6, and then to be fixed through the fixing body 7 and locking body 8, and other connecting bodies 4 is set to be shorter in length in such a way to allow the other ends of the connecting bodies to be pressed against another face of the plate body 5 and further to support the plate body 5, thereby controlling a distance between the plate body 5 and supporting steel body 9 effectively.

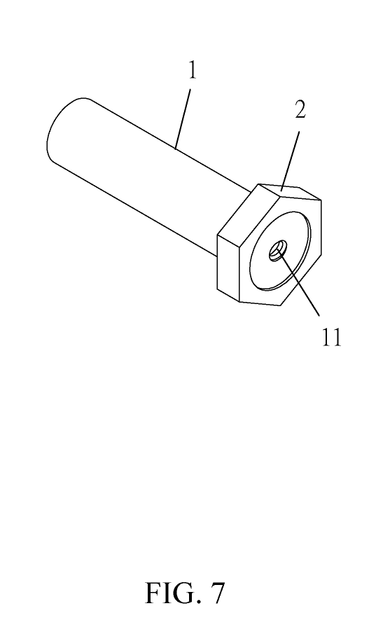

Referring to FIG. 7, which is a schematically perspective view of the present invention with a hexagonal flange, the flange 2 may be a circular, rectangular, triangular, hexagonal, octagonal or other geometrically shaped body besides the hexagonal one shown in the figure, they all can achieve the objects of the present invention similarly effectively.

I claim:

1. A shear screw nail, adapted to be in connection a steel skeleton, and comprising:
a resistance body, configured with a connecting portion at a predetermined position thereof, said connecting portion being hollow inside and configured with at least one connecting recess, and one end of said resistance body being configured with a flange.

2. The shear screw nail according to claim 1, wherein said connecting portion is configured on a center of said resistance body.

3. The shear screw nail according to claim 2, wherein said connecting portion is in connection with one end of a connecting body.

4. The shear screw nail according to claim 2, wherein a welding portion is configured on another end of said resistance body, and said resistance body is welded to a steel skeleton through said welding portion.

5. The shear screw nail according to claim 4, wherein said resistance body is a shear nail.

6. The shear screw nail according to claim 1, wherein said flange is larger than said resistance body in width.

7. The shear screw nail according to claim 6, wherein said flange is circular, rectangular, triangular, hexagonal or octagonal.

8. The shear screw nail according to claim 1, wherein said connecting recess is a spiral recess.
